(19) United States
(12) Patent Application Publication
(10) Pub. No.: US 2004/0003527 A1
(43) Pub. Date: Jan. 8, 2004

(54) Advertisement display device

(76) Inventor: Yeong-Nian Suen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/189,514

(22) Filed: Jul. 8, 2002

(51) Int. Cl. G09F 15/00

(52) U.S. Cl. 40/736; 40/610

(57) ABSTRACT

A display device includes an inflatable frame which is connected to an inlet valve and an outlet valve so as to inflate the frame within a short period of time. A plurality of and fixtures are connected to the inflatable frame so as to position the inflatable frame. A base board is enclosed by the inflatable frame and a plurality of support members are connected to the base board so as to position light bulbs. A display sheet is sandwiched between the base board and a transparent protection board.

### FIELD OF THE INVENTION

The present invention relates to a display device which includes a board enclosed by inflatable frame and light are connected to the board so as to illustrate the material to be shown on a transparent board. The display device is easily and conveniently to be set up and retrieved.

### BACKGROUND OF THE INVENTION

A conventional way to display a large scale of advertisement generally employs truss structure on a wall of a building and the display board is fixed to the truss structure so that people see the advertisement from a distance. The truss structure requires a lot of welding work and a lot of steel pieces that are fixed to the wall and/or connected with each other. The steel structure is so heavy so that it has to be connected to a building. Another way is to build a tower with a display area and the tower involves much more expensive cost. Both of the two type of structure for displaying the advertisement cannot be removed and is heavy in weight.

The present invention intends to provide a advertisement display device that uses an inflatable frame to enclose a board and the inflatable frame can be easily and conveniently to be built up and removed.

### SUMMARY OF THE INVENTION

In accordance with one aspect of the present invention, there is provided a display device which comprises an inflatable frame and fixtures for positioning the inflatable frame are connected to the inflatable frame. A base board is enclosed by the inflatable frame and a plurality of support members are connected to the base board so as to be position light bulbs.

The primary object of the present invention is to provide a display device which uses inflatable frame which is easily built and stored.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the display device of the present invention;

FIG. 2 is a perspective view to show the display device of the present invention is held by cables;

FIG. 3 shows the reinforcement plates in the inflatable frame of the display device of the present invention;

FIG. 4 shows light bulbs are received in recesses in the inflatable frame;

FIG. 5 shows the inlet valve of the display device of the present invention;

FIG. 6 shows the outlet valve of the display device of the present invention;

FIG. 7 shows the display device of the present invention is positioned on a wall;

FIG. 8 shows the display device of the present invention is connected to a frame on a wall;

FIG. 9 shows the display device of the present invention is connected to a post;

FIG. 10 shows the display device of the present invention has a weight received therein;

FIG. 11 shows a plurality of inflatable pieces are received in the inflatable frame;

FIG. 12 shows a protrusion extruding from the protection board; and

FIG. 13 shows the display device of the present invention has a wider portion on the top end and a narrow portion at the low end.

### DETAILED DESCRIPTION OF THE PREFERRED EMBODIMENT

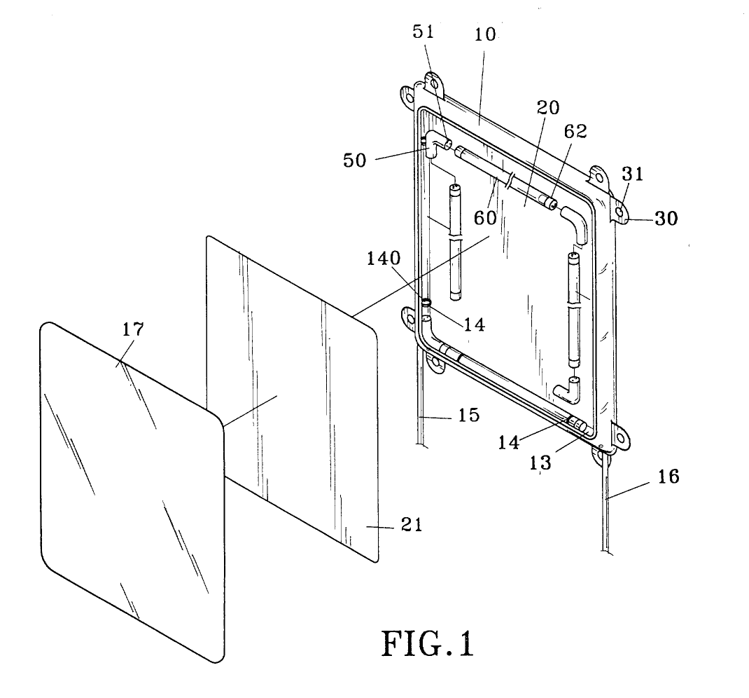

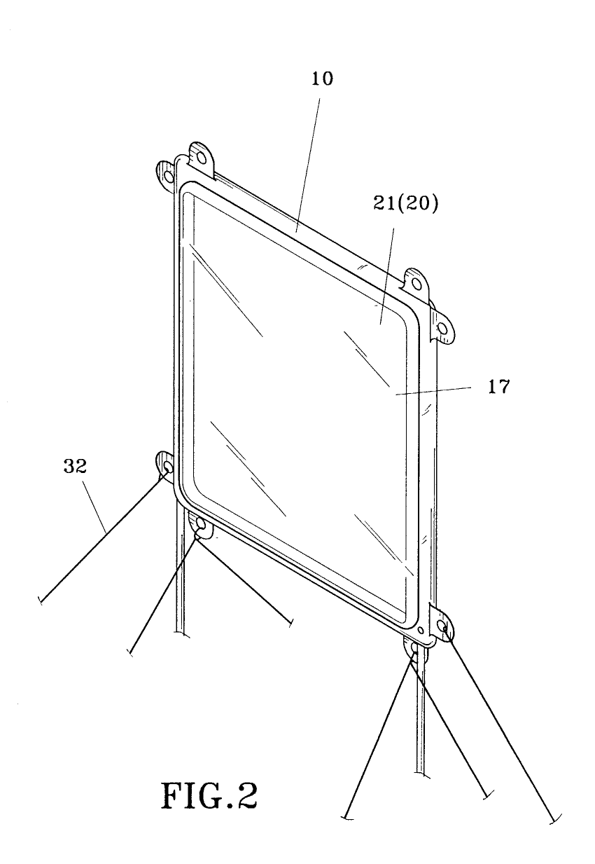

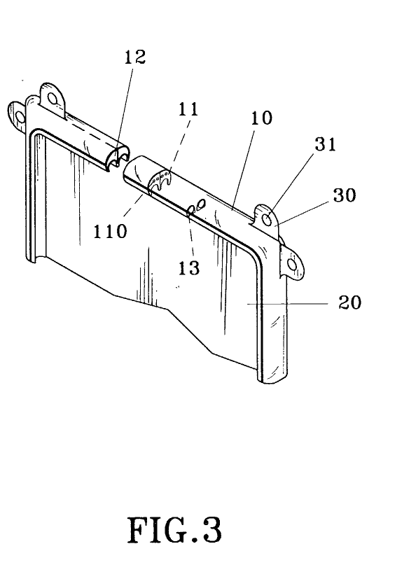

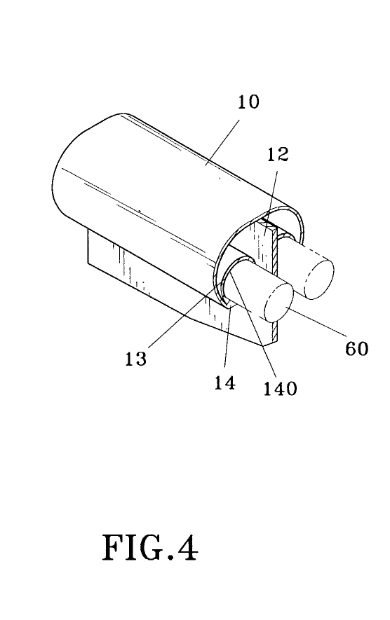

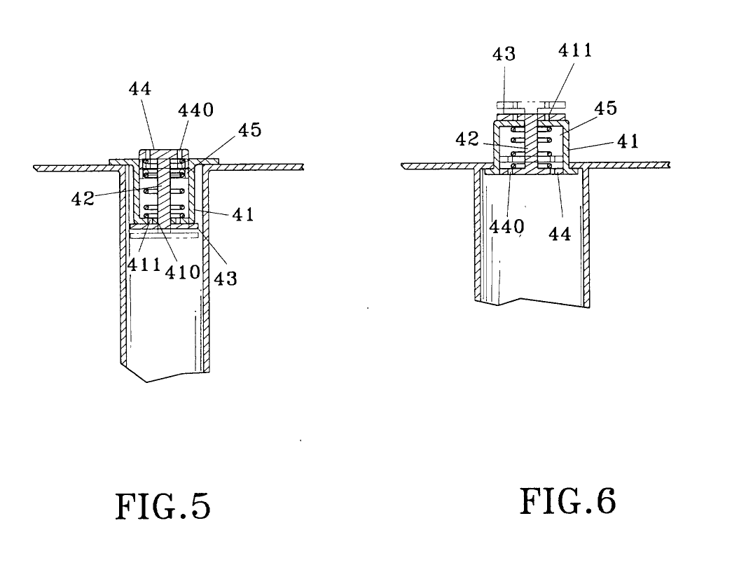

Referring to FIGS. 1, 3 and 4, the display device of the present invention comprises an inflatable frame 10 which has four sides and a plurality of fixtures 30 are connected to the inflatable frame 10 so that the device can be held in position by extending the cables 32 as shown in FIG. 2 through holes 31 in the fixtures 30. A base board 20 is enclosed by the inflatable frame 10 and a display sheet 21 is sandwiched between the base board 20 and a transparent protection board 17. The display sheet 21 has advertisement material printed thereon and is illuminated by the light bulbs 60 so that the advertisement material can be seen via the transparent board 17 from a distance.

The inflatable frame 10 has a separation plate 12 and a plurality of reinforcement plates 11 are received therein and each reinforcement plate 11 has holes 110 defined therethrough so that air reaches every partitions in the inflatable frame 10.

Two recesses 13 are defined in the inflatable frame 10 and a plurality of supporting members 50 are connected to the base board 20 and engaged with the recesses 13 such that the light bulbs 60 are positioned. Each recess 13 has a reinforcement rib 14 and a tubular member 140 is connected to the reinforcement rib 14 to clamp the light bulb 60. A receptacle 51 is connected to each of two ends of each of the support member 50 so that the plug ends 62 of the light bulbs 60 are connected to the receptacles 51.

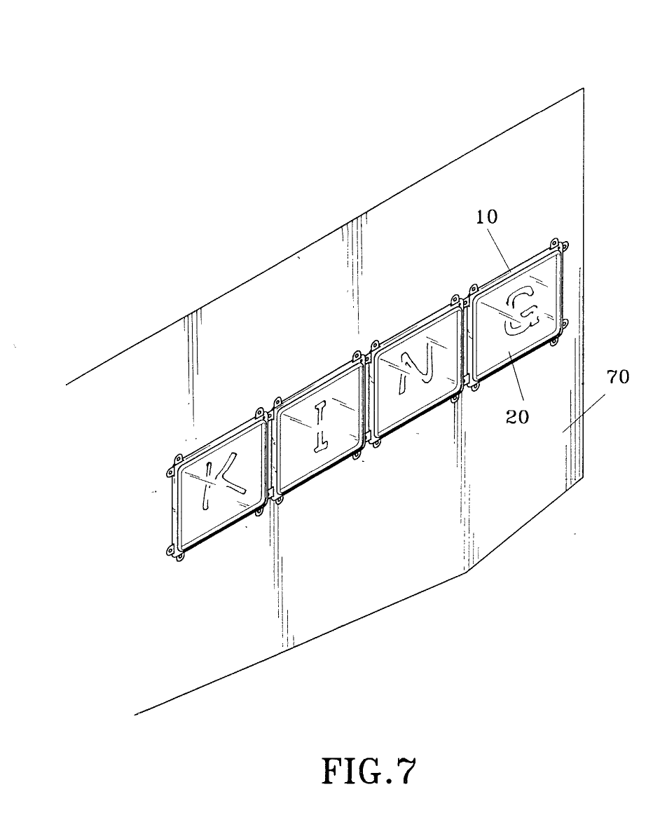

An inlet valve as shown 5 and an outlet valve as shown in FIG. 6 are connected to the inflatable frame 10 and two hoses 15 and 16 are respectively connected to the two inlet valve and the outlet valve so that the inflatable frame 10 can be inflated or flatted within a short period of time. Each of the inlet valve and the outlet valve has a casing 41 with an open end and a close end which has first apertures 411 defined therethrough. A shaft 42 movably extends through a central hole 410 in the close end and a seal 43 is connected to the shaft 42 so as to seal the first apertures 411. A head 44 is connected to the shaft 42 and engaged with the open end of the casing 41. A spring 45 is mounted to the shaft 42 and biased between the head 44 and the close end of the casing 41. A plurality of second apertures 440 are defined through the head 44.

When inflating the inflatable frame 10, pressurized air enters the casing 41 via the second apertures 440 and presses the spring 45 to lower the shaft 42 such that the seal 43 is removed away from the first apertures 411 to inflate the inflatable frame 10. When flatting the inflatable frame 10, the shaft 42 is moved in an opposite direction and the first apertures 411 are opened to allow the air in the inflatable frame 10 to be released.

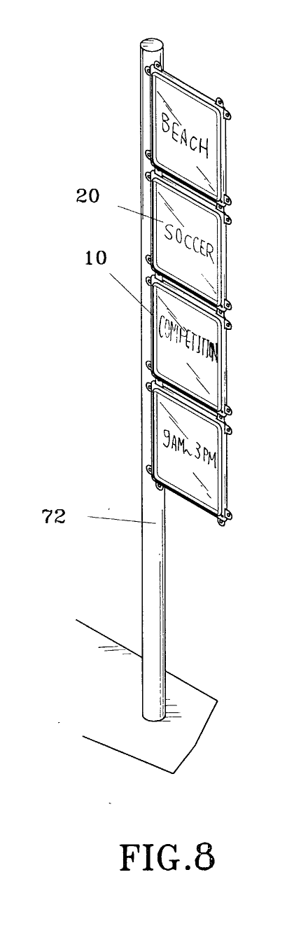

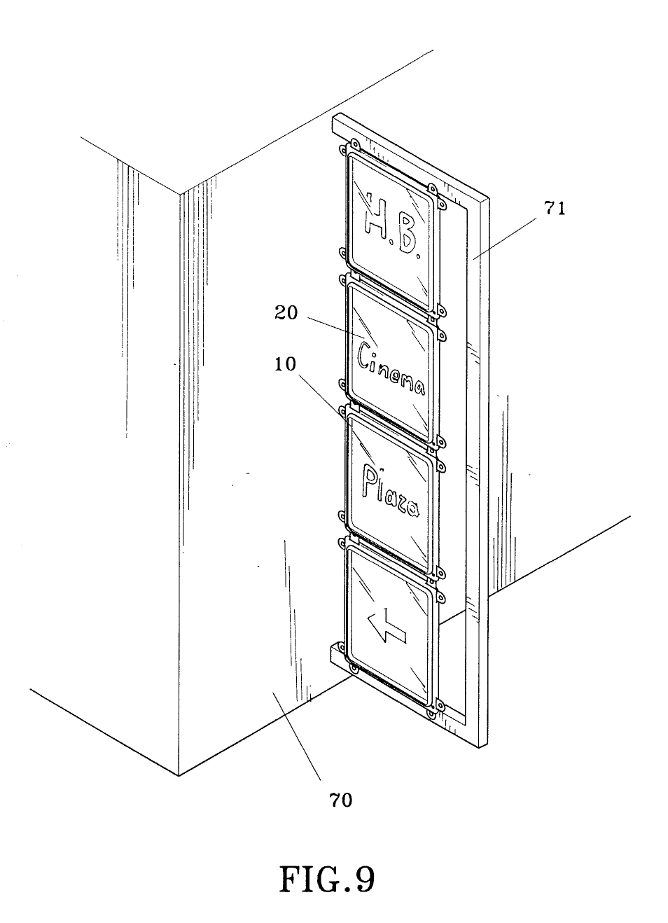

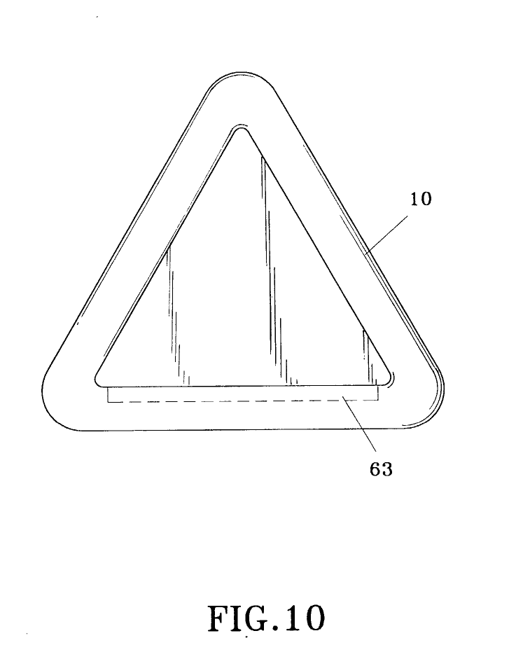

FIGS. 7 and 8 show that the display device of the present invention is positioned on a wall 70 and is connected to a frame 71 on the wall 70. FIG. 9 shows that the display device of the present invention is connected to a post 72. FIG. 10 shows that the inflatable frame 10 can be made to be a triangle frame and a weight 63 is received in the horizontal portion of the inflatable frame 10 to make the device stand on the ground.

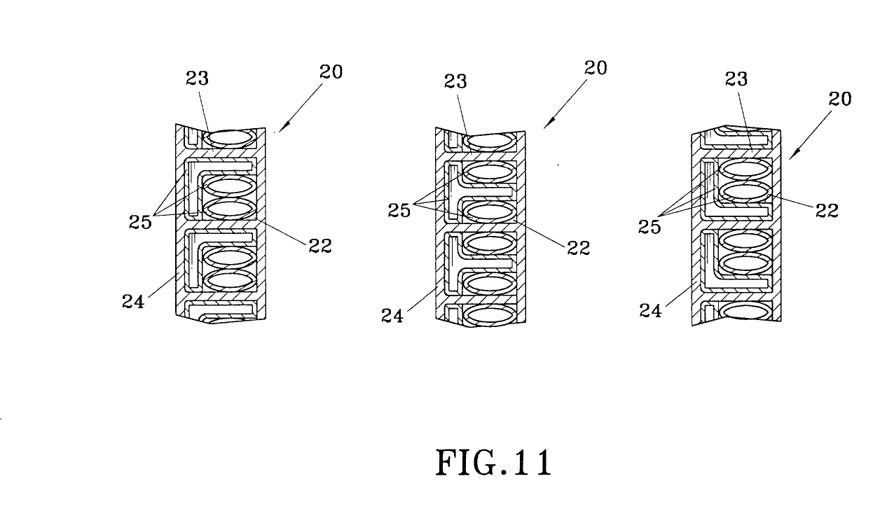

FIG. 11 shows a plurality of retaining members 22 received in the inflatable frame 10 and a plurality of inflatable pieces 25 are retained in each of the retaining members 22. A transparent plate 24 covers the retaining members 22 and patterns may be marked on the transparent plate 24. Each inflatable piece 25 is connected to its own inlet valve and outlet valve so that the inflatable piece 25 can be inflated or flatted according to the user's intention.

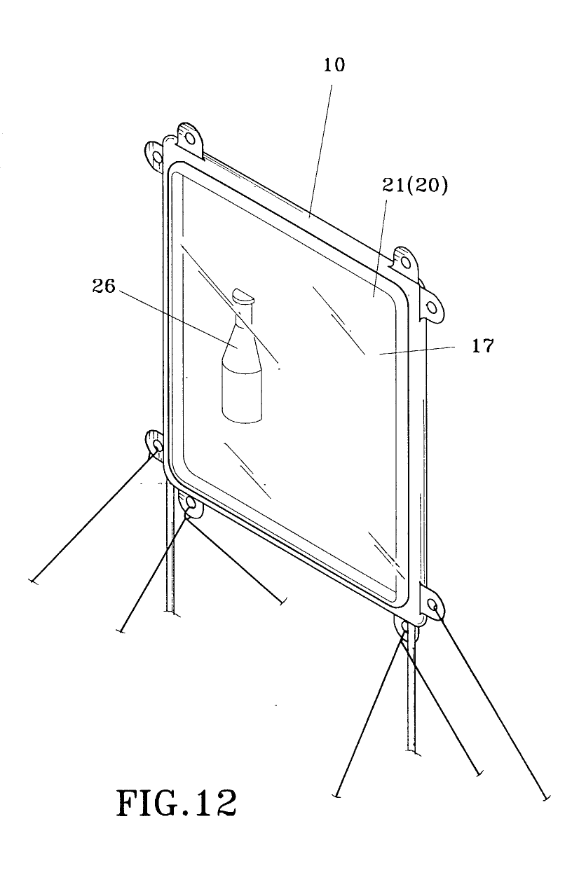

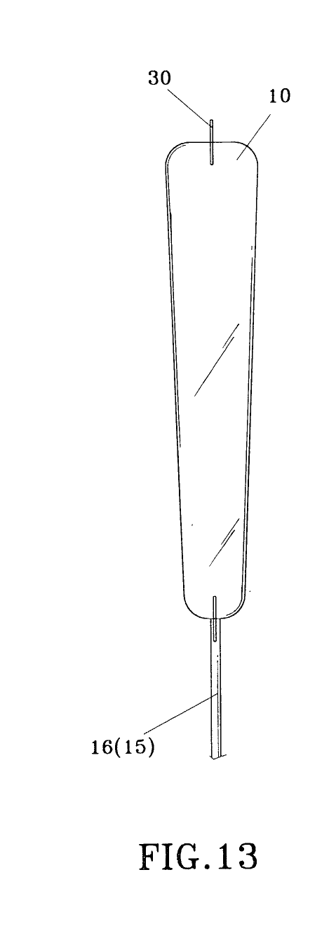

FIG. 12 shows that a protrusion 26 extending from the protection board 17 to provide a three dimensional effect of vision for the advertisement. FIG. 13 shows that the inflatable frame 10 is made to be a baseball-bat-like object.

While we have shown and described the embodiment in accordance with the present invention, it should be clear to those skilled in the art that further embodiments may be made without departing from the scope of the present invention.

What is claimed is:

1. A display device comprising:
an inflatable frame and fixtures connected to the inflatable frame, and
a base board enclosed by the inflatable frame and a plurality of support members connected to the base board so as to be adapted to position light bulbs.

2. The display device as claimed in claim 1, wherein the inflatable frame has a plurality of reinforcement plates received therein and each reinforcement plates has holes defined therethrough.

3. The display device as claimed in claim 1 further comprising two recesses defined in the inflatable frame and the supporting members engaged with the recesses.

4. The display device as claimed in claim 1 further comprising an inlet valve and an outlet valve connected to the inflatable frame, each of the inlet valve and the outlet valve having a casing with an open end and a close end which has first apertures defined therethrough, a shaft movably extending through the close end and a seal connected to the shaft so as to seal the first apertures, a head connected to the shaft and engaged with the open end of the casing, a spring mounted to the shaft and biased between the head and the close end of the casing, a plurality of second apertures defined through the head.

5. The display device as claimed in claim 1 further comprising a protection board and a display sheet which is sandwiched between the base board and the protection board.

6. The display device as claimed in claim 1 further comprising a receptacle connected to each of two ends of each of the support member.

7. The display device as claimed in claim 1 further comprising a weight received in the inflatable frame.

8. The display device as claimed in claim 1 further comprising a protrusion extending from the protection board.

9. The display device as claimed in claim 1 further comprising a plurality of retaining members received in the inflatable frame and a plurality of inflatable pieces retained in each of the retaining members.
